(19) United States
(12) Patent Application Publication
(10) Pub. No.: US 2022/0330098 A1
(43) Pub. Date: Oct. 13, 2022

(54) METHOD FOR ADJUSTING A TOTAL BANDWIDTH FOR A NETWORK DEVICE

(71) Applicant: Jotun Technology Inc., Hsinchu City (TW)

(72) Inventors: Shun Yuan YANG, Hsinchu City (TW); Chiao Min HU, Hsinchu City (TW); Wei Teng TAI, Hsinchu City (TW)

(21) Appl. No.: 17/496,477

(22) Filed: Oct. 7, 2021

(30) Foreign Application Priority Data
Apr. 7, 2021 (TW) 110112495

(51) Int. Cl. H04W 28/22; H04W 28/02

(52) U.S. Cl. CPC H04W 28/22; H04W 28/0268; H04W 28/0273; H04W 28/0289

(57) ABSTRACT

A method for adjusting a total bandwidth for a network device is provided. The method includes: for every predetermined time period, determining a data rate of receiving data packets by the network device through a network communication during the predetermined time period; designating the greater one of the data rate and the total bandwidth as a maximal data rate; when a preset condition is not satisfied, using the maximal data rate as the total bandwidth; and when the preset condition is satisfied, determining an adjusted data rate that is smaller than the maximal data rate based on the maximal data rate, and using the adjusted data rate as the total bandwidth.

### CROSS-REFERENCE TO RELATED APPLICATION

This application claims priority of Taiwanese Invention Patent Application No. 110112495, filed on Apr. 7, 2021.

### FIELD

The disclosure relates to a method for adjusting a total bandwidth, and more particularly to a method for adjusting a total bandwidth fora network device by using an adaptive control method.

### BACKGROUND

Conventionally, adjusting a total bandwidth for a network device involves user operation. In particular, a user has to operate a computer to execute a speed-test program to determine the total bandwidth by transmitting test data packets, and then manually adjust the total bandwidth of the network device. However, this approach may be inconvenient and labor intensive, and the total bandwidth determined thereby may be inappropriate for an instantaneous change in network condition.

### SUMMARY

Therefore, an object of the disclosure is to provide a method for adjusting a total bandwidth for a network device in one of an uploading direction and a downloading direction, wherein the method can alleviate at least one of the drawbacks of the prior art.

According to the disclosure, the method includes steps of:
for every predetermined time period, determining an input data rate that is a data rate of receiving data packets by the network device through a network communication during the predetermined time period;
designating the greater one of the input data rate and the total bandwidth as a maximal data rate;
determining whether a preset condition is satisfied;
when it is determined that the preset condition is not satisfied, using the maximal data rate as the total bandwidth for the network device; and
when it is determined that the preset condition is satisfied, determining an adjusted data rate that is smaller than the maximal data rate based on the maximal data rate, and using the adjusted data rate as the total bandwidth for the network device.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating an example of a network device that implements an embodiment of a method for adjusting a total bandwidth according to the disclosure;

FIG. 2 is a flow chart illustrating the embodiment of the method according to the disclosure.

### DETAILED DESCRIPTION

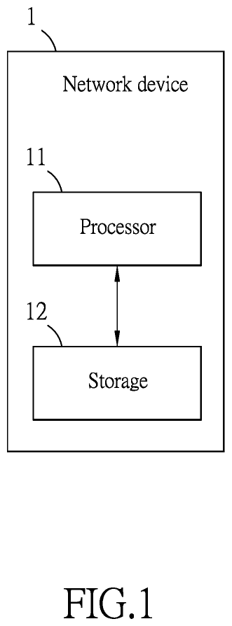

Referring to FIG. 1, an embodiment of a network device 1 is provided to implement a method for adjusting a total bandwidth for the network device 1 in one of an uploading direction and a downloading direction according to the disclosure. The total bandwidth is to be assigned to the network device 1. It should be noted that the total bandwidth herein is a maximal bandwidth (rate of data transfer) which the network device 1 can support in one of the uploading direction and the downloading direction, rather than an actual bandwidth (current rate of data transfer) at which the network device 1 is communicating with other network devices. In one embodiment, the total bandwidth has a predetermined numerical value, and is for example, 1000 Mbps.

The network device 1 may be a router or an endpoint device (e.g., a personal computer, a mobile phone, a server or any device that has a network communication ability).

In the case that the network device 1 is an endpoint device, transmission in the uploading direction means data transmission from the network device 1 to another endpoint device via a router, and transmission in the downloading direction means data transmission from another endpoint device to the network device 1 via a router. In the case that the network device 1 is a router, the network device 1 receives data from an endpoint device, and then transmits the data to another endpoint device, and transmission in the downloading direction means that the network device 1 receives data from an endpoint device, and transmission in the downloading direction means that the network device 1 transmits the data to another endpoint device.

The network device 1 includes a processor 11 and a storage 12.

The processor 11 may be implemented by a central processing unit (CPU), a microprocessor, a micro control unit (MCU), a system on a chip (SoC), or any circuit configurable/programmable in a software manner and/or hardware manner to implement functionalities discussed in this disclosure.

The storage 12 may be implemented by flash memory, a hard disk drive (HDD) or a solid state disk (SSD), electrically-erasable programmable read-only memory (EEPROM) or any other non-volatile memory devices, but is not limited thereto.

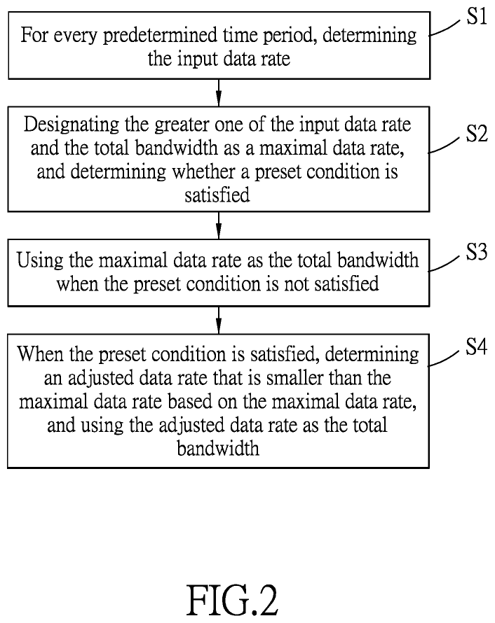

Referring to FIG. 2, the method for adjusting the total bandwidth includes steps S1 to S4 delineated below according to an embodiment of this disclosure.

In step S1, for every predetermined time period (e.g., 10 seconds), the processor 11 of the network device 1 determines an input data rate that is a data rate of receiving data packets by the network device 1 through the network communication during the predetermined time period. It should be noted that the input data rate is determined for only one of the uploading direction and the downloading direction of the network communication.

In step S2, the processor 11 of the network device 1 designates the greater one of the input data rate and the total bandwidth as a maximal data rate. It should be noted that at the beginning of using the network device 1, the total bandwidth is designated as the maximal data rate and is set to be zero as an initial value of the maximal data rate, and the input data rate will be designated as the maximal data rate when the input data rate is greater than the total bandwidth, which is equal to zero at first. However, the total bandwidth may also be initially set to have any non-zero value.

Then, the processor 11 determines whether a preset condition is satisfied. When it is determined that the preset condition is not satisfied, the flow of procedure proceeds to step S3. Oppositely, when it is determined that the preset condition is satisfied, the flow of procedure proceeds to step S4.

In one embodiment, the preset condition is that a preset time period has elapsed. The preset time period is exemplarily twelve hours.

In one embodiment, the preset condition is that a first preset time period has elapsed and the input data rate continues to be smaller than the total bandwidth for a second preset time period. In this embodiment, the first preset time period is exemplarily twelve hours, and the second preset time period is exemplarily two hours, but implementations of the first preset time period and the second preset time period are not limited to the disclosure herein and may vary in other embodiments.

In one embodiment, the preset condition is that network congestion occurs in the network communication. In particular, the processor 11 determines whether network congestion occurs in the network communication by determining whether packet loss occurs in the network communication. In other embodiments, the processor 11 may determine whether network congestion occurs by determining whether network congestion has occurred or is going to occur based on an estimated index.

For example, with respect to communication under transmission control protocol (TCP), when a sender transmits a data segment, the sender initializes a retransmission timeout (RTO) timer which estimates an arrival time of an acknowledgement for the transmitted data segment. The sender (e.g., the processor 11) determines that the transmitted data segment may be damaged or lost and retransmits the same data segment when the sender receives no acknowledgement by the time the RTO timer expires (i.e., the arrival time has elapsed). It is worth to note that retransmission of data packets can be utilized as the estimated index to determine whether network congestion has occurred.

In step S3, the processor 11 of the network device 1 uses the maximal data rate as the total bandwidth for the network device 1. That is to say, the total bandwidth in the uploading direction is equal to the maximal data rate in the uploading direction when the input data rate is determined with respect to the uploading direction; and the total bandwidth in the downloading direction is equal to the maximal data rate in the downloading direction when the input data rate is determined with respect to the downloading direction.

In step S4, the processor 11 of the network device 1 determines an adjusted data rate that is smaller than the maximal data rate based on the maximal data rate, and uses the adjusted data rate as the total bandwidth for the network device 1.

In one embodiment, the processor 11 of the network device 1 calculates the adjusted data rate by multiplying the maximal data rate by a preset percentage ranging between 0% and 100%, e.g., 90%.

In one embodiment, the processor 11 of the network device 1 calculates the adjusted data rate by subtracting a preset rate from the maximal data rate, where the preset rate ranges between 0 and the maximal data rate, and is exemplarily 10 Mbps.

In one embodiment where the preset condition is that a preset time period of twelve hours have elapsed, the processor 11 reduces the total bandwidth by 10% or by 10 Mbps every twelve hours.

In one embodiment, when it is determined by the processor 11 that twelve hours have elapsed and the input data rate continues to be smaller than the total bandwidth for two hours, the processor 11 reduces the total bandwidth by 10% or by 10 Mbps.

In one embodiment, when it is determined by the processor 11 that network congestion occurs in the network communication, the processor 11 reduces the total bandwidth by 10% or by 10 Mbps.

In summary, the method according to the disclosure is an adaptive control method to automatically and dynamically reduce the total bandwidth for the network device 1 when the network communication is not in a good condition (e.g., network congestion occurs) and support for the originally designated total bandwidth is adversely affected. In this way, stability of the network communication may be maintained. Moreover, because the method involves no manual operation, time and labor may be saved, consequently.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for adjusting a total bandwidth for a network device in one of an uploading direction and a downloading direction, the method comprising steps of:
for every predetermined time period, determining an input data rate that is a data rate of receiving data packets by the network device through a network communication during the predetermined time period;
designating the greater one of the input data rate and the total bandwidth as a maximal data rate;
determining whether a preset condition is satisfied;
when it is determined that the preset condition is not satisfied, using the maximal data rate as the total bandwidth for the network device; and
when it is determined that the preset condition is satisfied, determining an adjusted data rate that is smaller than the maximal data rate based on the maximal data rate, and using the adjusted data rate as the total bandwidth for the network device.

2. The method as claimed in claim 1, wherein the step of determining an adjusted data rate includes calculating the adjusted data rate by multiplying the maximal data rate by a preset percentage ranging between 0% and 100%.

3. The method as claimed in claim 1, wherein the step of determining an adjusted data rate includes calculating the adjusted data rate by subtracting a preset rate from the maximal data rate, the preset rate ranging between 0 and the maximal data rate.

4. The method as claimed in claim 1, wherein the preset condition is that a preset time period has elapsed.

5. The method as claimed in claim 1, wherein the preset condition is that a first preset time period has elapsed and the input data rate continues to be smaller than the total bandwidth for a second preset time period.

6. The method as claimed in claim 1, wherein the preset condition is that network congestion occurs in the network communication.
